(19) United States
(12) Patent Application Publication
(10) Pub. No.: US 2026/0296114 A1
(43) Pub. Date: Oct. 1, 2026

(54) JOINT LOCKING AXIAL FASTENING SYSTEM

(71) Applicant: Ford Global Technologies, LLC, Dearborn, MI (US)

(72) Inventors: Larry A. Cox, Winston Salem, NC (US); Jerome Fatheree, Romulus, MI (US)

(73) Assignee: Ford Global Technologies, LLC, Dearborn, MI (US)

(21) Appl. No.: 19/091,959

(22) Filed: Mar. 27, 2025

(51) Int. Cl. B60D 1/52; B60D 1/06; F16B 7/04

(52) U.S. Cl. CPC B60D 1/52; B60D 1/06; F16B 7/0406

(57) ABSTRACT

An axial fastening system includes an externally threaded part having a free end and a peripheral groove spaced from the free end. A internally threaded part can rotatably receive the externally threaded part, the internally threaded part having a top side and a bottom side, wherein the internally threaded part defines a center aperture having a first sidewall extending between the top and bottom sides, wherein the center aperture defines a peripheral cavity proximate the top side of the internally threaded part, the peripheral cavity having a top wall, a bottom wall, and a second sidewall extending between the top and bottom walls, wherein the second sidewall is recessed relative to the first sidewall of the center aperture. A retention feature is disposed within the peripheral cavity, wherein the retention feature is configured to extend into the peripheral groove of the externally threaded part.

### FIELD OF THE DISCLOSURE

The present disclosure generally relates to a fastening system, and specifically, an axial locking system for a fastening system.

### BACKGROUND OF THE INVENTION

Trailer hitches for vehicles are commonly configured to receive a variety of hitch accessories, including but not limited to ball mounts, bike racks, and cargo carriers. Hitch accessories are generally coupled to a trailer hitch with a primary locking feature such as a threaded bolt-and-nut combination. Due to the generally removable nature of hitch accessories and the widespread use of a threaded bolt-and-nut locking feature, it is desirable for a primary locking feature to be equipped with a secondary locking feature to inhibit unlocking of the primary locking feature. Known secondary locking features include cotter pins, safety wire, Nylon-insert lock nuts, lock washers, thread-locking adhesives, and prevailing torque lock nuts. Such secondary locking features may be cumbersome to implement. There is therefore a need for a locking system with an enhanced secondary locking mechanism that may be used for coupling hitch accessories to trailer hitches of vehicles.

### SUMMARY OF THE DISCLOSURE

According to a first aspect of the present disclosure, a trailer hitch axial fastening system includes a trailer ball configured to be removably coupled to a trailer hitch of a vehicle and to receive an accessory component, a threaded bolt extending from the trailer ball, the threaded bolt defining a free end and a peripheral groove spaced from the free end, and a threaded nut configured to rotatably receive the threaded bolt, the threaded nut defining a top side, a bottom side, and a center aperture, wherein the center aperture defines a first sidewall lined with internal threads and a peripheral cavity proximate the top side of the threaded nut, and wherein the peripheral cavity defines a top wall, a bottom wall, and a second sidewall extending between the top and bottom walls, wherein the second sidewall is recessed relative to the first sidewall. The trailer hitch axial fastening system further includes an elastic annular ring disposed within the peripheral cavity of the threaded nut, wherein the elastic annular ring applies a compression force around the threaded bolt when the threaded bolt extends through the threaded nut such that the elastic annular ring is not aligned with the peripheral groove, and wherein the elastic annular ring extends into the peripheral groove when the threaded bolt extends through the threaded nut such that the elastic annular ring is aligned with the peripheral groove, the elastic annular ring including a ridge having a first radius, wherein the ridge is configured to extend into the peripheral groove when the threaded bolt extends through the threaded nut such that the elastic annular ring is aligned with the peripheral groove.

Embodiments of the first aspect of the present disclosure can include any one or a combination of the following features:
The elastic annular ring further includes a first section extending along the second sidewall, a second section laterally defining the ridge, and a third section extending along the second sidewall, wherein the second section of the elastic annular ring interposes the first and third sections of the elastic annular ring.
When the threaded bolt extends through the threaded nut such that the elastic annular ring is not aligned with the peripheral groove, the ridge of the elastic annular ring is laterally displaced toward the second sidewall of the peripheral cavity.
When the threaded bolt extends through the threaded nut such that the elastic annular ring is not aligned with the peripheral groove, the first section of the elastic annular ring is slidably displaced toward the top wall and/or the third section of the elastic annular ring is slidably displaced toward the bottom wall.
The first and third sections of the elastic annular ring are substantially equal in length.
The elastic annular ring further includes a first transition section interposing the first and second sections, wherein the first transition section defines a second radius, and a second transition section interposing the second and third sections, wherein the second transition section defines a third radius.
The second and third radii are substantially equal.
The threaded nut is removably coupled to the threaded bolt when the ridge of the elastic annular ring is received by the peripheral groove.
The center aperture of the threaded nut defines a first diameter, wherein the ridge of the elastic annular ring defines a second diameter, and wherein the first diameter is greater than the second diameter.

According to a second aspect of the present disclosure, a fastening system includes an externally threaded part having a free end and a peripheral groove spaced from the free end, and an internally threaded part having a top side and a bottom side, wherein the internally threaded part defines a center aperture extending between the top side and the bottom side along a centerline, wherein the center aperture defines a first sidewall, and wherein the internally threaded part defines a peripheral cavity proximate the top side, the peripheral cavity having a top wall, a bottom wall, and a second sidewall extending between the top and bottom walls, wherein the second sidewall is recessed relative to the first sidewall of the center aperture. The fastening system further includes a retention feature disposed within the peripheral cavity and configured to engage with the peripheral groove when the externally threaded part extends through the internally threaded part such that the retention feature aligns with the peripheral groove, the retention feature including a first section extending along the second sidewall of the peripheral cavity and defining a top edge of the retention feature, a second section laterally spaced from the second sidewall of the peripheral cavity, and a third section extending along the second sidewall of the peripheral cavity and defining a bottom edge of the retention feature, wherein the second section interposes the first and third sections.

Embodiments of the second aspect of the present disclosure can include any one or a combination of the following features:
The second section includes a ridge having an apex, and wherein the apex is displaced toward the second sidewall when the externally threaded part extends through the internally threaded part and the ridge is not aligned with the peripheral groove.
The retention feature defines a uniform thickness.
An overall length of the retention feature is less than a length of the second sidewall.
A distance between the first and second sections of the retention feature is greater when the externally threaded part extends through the internally threaded part and the ridge is not aligned with the peripheral groove as compared to when the ridge extends into the peripheral groove.
When the externally threaded part extends through the internally threaded part and the ridge extends into the peripheral groove, the ridge provides axial resistance against removing the internally threaded part from the externally threaded part without providing significant prevailing torque between the externally threaded part and the internally threaded part.

According to a third aspect of the present disclosure, an axial fastening system includes an externally threaded part having a free end and a peripheral groove spaced from the free end, and a internally threaded part configured to rotatably receive the externally threaded part, the internally threaded part having a top side and a bottom side, wherein the internally threaded part defines a center aperture having a first sidewall extending between the top and bottom sides along a centerline, wherein the center aperture defines a peripheral cavity proximate the top side of the internally threaded part, the peripheral cavity having a top wall, a bottom wall, and a second sidewall extending between the top and bottom walls, wherein the second sidewall is recessed relative to the first sidewall of the center aperture. The axial fastening system further includes a retention feature disposed within the peripheral cavity, wherein the retention feature is configured to extend into the peripheral groove of the externally threaded part, the retention feature including a first section extending along the second sidewall of the peripheral cavity, a second section defining a ridge extending toward the centerline, wherein the second section is spaced from the second sidewall when the retention feature extends into the peripheral groove of the externally threaded part, and a third section extending along the second sidewall of the peripheral cavity.

Embodiments of the third aspect of the present disclosure can include any one or a combination of the following features:
The ridge of the retention feature further includes a first portion extending from the first section and a second portion extending from the second section, wherein the second portion converges with the first portion at an apex of the ridge.
The retention feature further includes a first transition section interposing the first section of the retention feature and the first portion of the ridge, wherein the first transition section defines a first radius, and a second transition section interposing the third section of the retention feature and the second portion of the ridge, wherein the second transition section defines a second radius.
The ridge extends into the center aperture further than the first sidewall.
The first section of the retention feature is substantially parallel to the third section of the retention feature.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top perspective view of a rear end of a vehicle including a trailer hitch, where an axial locking system couples a hitch accessory to the trailer hitch;

FIG. 2 is a side perspective view of the hitch accessory including a ball stud and an externally threaded part defining a peripheral groove proximate a free end of the externally threaded part;

FIG. 3 is a side cross-sectional view of an internally threaded part taken along a center longitudinal axis of a center aperture of the internally threaded part, where the internally threaded part is configured to rotatably couple to the externally threaded part;

FIG. 4 is a detailed schematic view of the retention feature disposed within the peripheral cavity of the internally threaded part;

FIG. 5 is a top perspective view of the retention feature;

FIG. 6 is a schematic cross-sectional view of the retention feature including a first section, a second section, a third section, a first transition section interposing the first and second sections, and a second transition section interposing the second and third sections;

FIG. 7 is an exploded perspective view of the axial fastening system incorporated into a first vehicle suspension assembly; and

FIG. 8 is an exploded perspective view of the axial fastening system incorporated into a second vehicle suspension assembly.

### DETAILED DESCRIPTION OF PREFERRRD EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show conceptual and/or function overview. Therefore, specific structural and functional details disclosed herein are not to be interpreted as limiting, but merely as a representative basis for teaching one skilled in the art to variously employ the present disclosure.

For purposes of description herein, the terms “upper,” “lower,” “right,” “left,” “rear,” “front,” “vertical,” “horizontal,” and derivatives thereof shall relate to the concepts as oriented in FIG. 3. However, it is to be understood that the concepts may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to an axial fastening system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

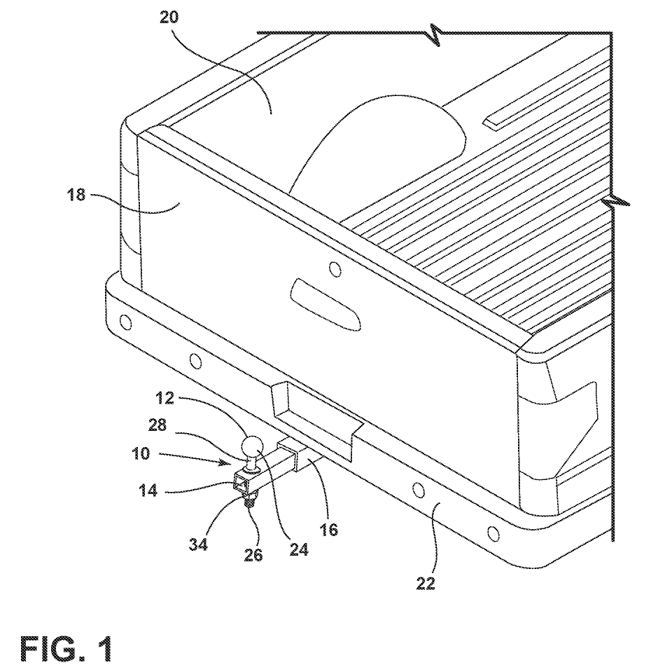

With initial reference to FIG. 1, reference numeral 10 generally designates an axial fastening system. As illustrated, the axial fastening system 10 includes a hitch accessory 12 removably coupled to an intermediate component 14 received by a trailer hitch 16 of a rear end 18 of a vehicle 20. The vehicle 20 may be a motor vehicle such as a wheeled motor vehicle having a motor such as an internal combustion engine, an electric battery powered motor, or a hybrid system having a combination of an internal combustion engine and an electric battery, for example. The trailer hitch 16 may be coupled to a vehicle frame, a vehicle bumper 22, or another location on the vehicle 20. Furthermore, the hitch accessory 12 may be removably coupled directly to the trailer hitch 16, the vehicle frame, the vehicle bumper 22, or another location on the vehicle 20.

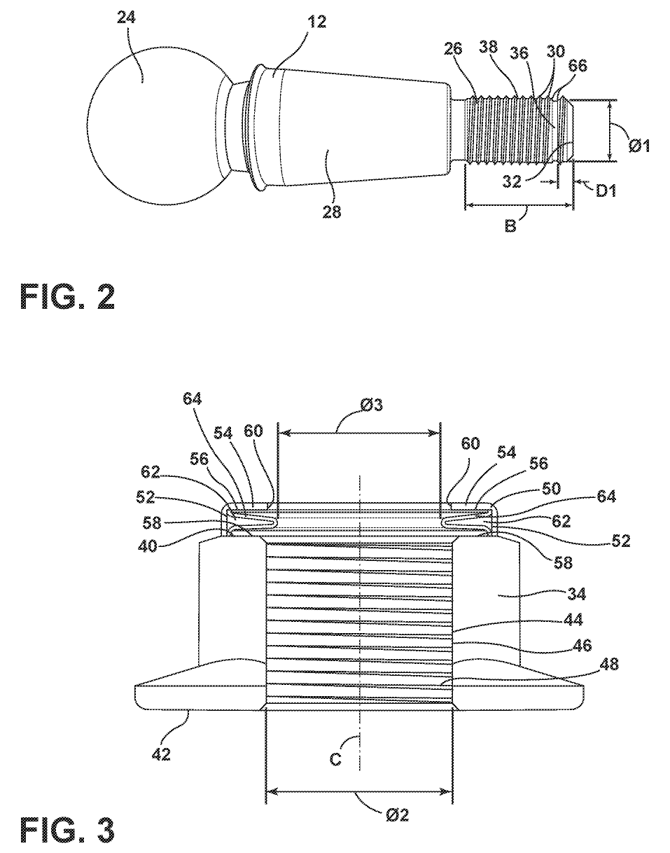

With reference to FIGS. 1 and 2, the hitch accessory 12 of the axial fastening system 10 is a trailer ball including a ball stud 24 and an externally threaded part 26 extending from the ball stud 24. The ball stud 24 is configured to receive a trailer coupler of a trailer or another supplementary attachment, and the ball stud 24 may vary in size depending on the type of supplementary attachment a user desires to couple to the ball stud 24, for example. According to some aspects, the ball stud 24 may be a 1.875-inch-diameter ball stud, a 2-inch-diameter ball stud, a 2.3125-inch-diameter ball stud, or a 3-inch-diameter ball stud. Additionally, the hitch accessory 12 may include other components in addition to or instead of the ball stud 24, and the externally threaded part 26 may extend from another component. For example, the ball stud 24 may be supplemented or substituted with a trailer coupler adapter, a hitch-mounted cargo carrier, a bike rack, a fifth-wheel trailer hitch, or a component therein such as a bolt head. Furthermore, the intermediate component 14 (FIG. 1) to which the hitch accessory 12 is removably coupled may be a trailer coupler adapter, a hitch-mounted cargo carrier, a bike rack, a fifth-wheel trailer hitch, or a component therein, for example. As illustrated, the ball stud 24 and the externally threaded part 26 are interposed by a tapered intermediate member 28 configured to be seated within a mounting hole of the intermediate component 14, where the intermediate member 28 extends from the ball stud 24 and the externally threaded part 26 extends from the intermediate member 28. Alternatively, the externally threaded part 26 may extend directly from the ball stud 24, and/or the intermediate member 28 may be cylindrical and not tapered.

The externally threaded part 26 of the hitch accessory 12 is a threaded bolt defining a first diameter Ø1 and external threads 30 extending between the intermediate member 28 and a free end 32 of the externally threaded part 26. The externally threaded part 26 further defines a bolt length B, and the free end 32 is configured to rotatably couple to an internally threaded part 34. The external threads 30 may be formed on the externally threaded part 26 by a process such as molding, rolling, cutting, or grinding, for example. The externally threaded part 26 also defines an unthreaded, concave peripheral groove 36 spaced from the free end 32 and extending circumferentially around the externally threaded part 26. According to some aspects, the bolt length B of the externally threaded part 26 may vary. The peripheral groove 36 and the free end 32 of the externally threaded part 26 are separated by a first distance D1 which may also vary. For example, the peripheral groove 36 may be situated proximate the free end 32 of the externally threaded part 26 or proximate a midpoint 38 of the externally threaded part 26. Additionally, the external threads 30 may be provided within the peripheral groove 36, and the peripheral groove 36 may be squared, tapered, or rounded, for example. It is also contemplated that the peripheral groove 36 may be convex. In some instances, the externally threaded part 26 of the hitch accessory 12 may be a threaded screw.

With reference to FIGS. 1-3, the axial fastening system 10 includes the internally threaded part 34 configured to rotatably couple to the externally threaded part 26 of the hitch accessory 12. The internally threaded part 34 is a threaded nut defining a top side 40, a bottom side 42, and a center aperture 44 extending between the top and bottom sides 40, 42 along a centerline C, the center aperture 44 being configured to receive the externally threaded part 26. The center aperture 44 defines a first sidewall 46 with a second diameter Ø2, where the first sidewall 46 defines internal threads 48 configured to interlock with the external threads 30 of the externally threaded part 26. The internal threads 48 may be formed on the first sidewall 46 by a process such as molding, rolling, cutting, or grinding, for example. It is contemplated that the internally threaded part 34 and/or the externally threaded part 26 may include secondary locking mechanisms such as cotter pins, safety wire, Nylon-insert lock nuts, lock washers, thread-locking adhesives, and prevailing torque lock nuts, for example.

In one exemplary assembly process of the axial fastening system 10, the free end 32 of the externally threaded part 26 can be positioned at the bottom side 42 of the internally threaded part 34, the externally threaded part 26 extending substantially along the centerline C of the center aperture 44. The externally threaded part 26 is then rotated in a first direction relative to the internally threaded part 34, and the external threads 30 at the free end 32 engage with the internal threads 48 of the center aperture 44 such that the externally threaded part 26 advances axially through the center aperture 44 of the internally threaded part 34 toward the top side 40. The free end 32 of the externally threaded part 26 may have partial threads that assist with initiating the engagement between the externally threaded part 26 and the internally threaded part 34. Additionally, an external force urging the externally and internally threaded parts 26, 34 together may be needed to create initial contact between the externally threaded part 26 and the internally threaded part 34 and to thereafter engage the external and internal threads 30, 48. The externally threaded part 26 may be further rotated in the first direction such that the free end 32 of the externally threaded part 26 passes through the top side 40 of the internally threaded part 34. In some instances, the internally threaded part 34 may be additionally or alternatively rotated. According to some aspects, the top side 40 of the internally threaded part 34 may first receive the free end 32 of the externally threaded part 26. Furthermore, the externally threaded part 26 may be rotated in a second direction relative to the internally threaded part 34 to advance the externally threaded part 26 out of the center aperture 44 of the internally threaded part 34.

With reference to FIG. 3, the internally threaded part 34 further includes a casing 50 extending from the top side 40 of the internally threaded part 34. The casing 50 defines a second sidewall 52 and includes a flange 54 extending toward the centerline C of the center aperture 44. The second sidewall 52 of the casing 50 extends between a top wall 56 defined by the flange 54 and a bottom wall 58 defined by the top side 40 of the internally threaded part 34. The casing 50 further defines a peripheral cavity 62 containing a retention feature 64. Specifically, the peripheral cavity 62 is defined by the top wall 56, the bottom wall 58, and the second sidewall 52, and the second sidewall 52 is recessed relative to the first sidewall 46 of the center aperture 44 in a direction away from the centerline C. It is contemplated that the internally threaded part 34 may not include the casing 50 in some instances. Accordingly, the center aperture 44 may define the peripheral cavity 62 between the top and bottom sides 40, 42 of the internally threaded part 34. Alternatively, the retention feature 64 may be coupled to the internally threaded part 34 yet situated external to the internally threaded part 34. In other instances, the internally threaded part 34 may include a plurality of peripheral cavities 62, each of which may contain the retention feature 64.

With reference to FIGS. 2 and 3, the retention feature 64 is a convex, elastic annular ring that is disposed within the peripheral cavity 62, extends into the center aperture 44 toward the centerline C, and is configured to engage with the concave peripheral groove 36 of the externally threaded part 26. The retention feature 64 may be made of an elastic metallic material or another elastic material. In configurations where the peripheral groove 36 is convex, the retention feature 64 may be concave and configured to receive the peripheral groove 36. It is contemplated that the externally threaded part 26 may alternatively define the peripheral cavity 62 extending circumferentially around the externally threaded part 26, where the retention feature 64 is disposed within and extends outward from the peripheral cavity 62, and the peripheral groove 36 may be defined by the internally threaded part 34 at a location such as the first sidewall 46 or the casing 50.

Regarding the assembly of the axial fastening system 10 (FIG. 1), an unassembled configuration is a configuration where the top and bottom sides 40, 42 of the internally threaded part 34 do not receive the externally threaded part 26 and the retention feature 64 maintains an original shape. In a partially assembled position, the top and bottom sides 40, 42 of the internally threaded part 34 receive the externally threaded part 26, the retention feature 64 is not aligned with the peripheral groove 36 of the externally threaded part 26, and the retention feature 64 is in contact with the externally threaded part 26 such that the retention feature 64 is deformed. In a fully assembled position, the top and bottom sides 40, 42 of the internally threaded part 34 receive the externally threaded part 26, the retention feature 64 aligns with the peripheral groove 36 of the externally threaded part 26, and the retention feature 64 engages with and extends into the peripheral groove 36 such that the retention feature 64 at least partially returns to an original shape. When the axial fastening system 10 is in the fully assembled position, the engagement between the retention feature 64 and the peripheral groove 36 provides resistance against axial movement of the internally threaded part 34 relative to the externally threaded part 26 out of the fully assembled position. Particularly, when the retention feature 64 is in contact with one of a pair of lips 66 of the peripheral groove 36, the contact between the retention feature 64 and the lip 66 provides resistance against axial movement of the internally threaded part 34 relative to the externally threaded part 26. There may be no significant prevailing torque between the internally threaded part 34 and the externally threaded part 26 in the fully assembled position. The ridge 78 may be in contact with one, both, or neither of the pair of lips 66 of the peripheral groove 36 while in the fully assembled position. The fully assembled position may provide a limited range of axial movement of the internally threaded part 34 relative to the externally threaded part 26 without significant resistance against the axial movement, and the limited range may be up to the length of the externally threaded part 26.

According to some aspects, the internally threaded part 34 may be manufactured such that the free edge 60 of the casing 50 initially extends from the second sidewall 52 substantially parallel to the centerline C of the center aperture 44. The retention feature 64 may then be disposed within the casing 50 such that the retention feature 64 is retained by the bottom wall 58 and the second sidewall 52. The casing 50 proximate the free edge 60 may then be crimped such that the free edge 60 is extended toward the centerline C relative to the second sidewall 52, thereby forming the flange 54 and the top wall 56 of the peripheral cavity 62 and retaining the retention feature 64 within the peripheral cavity 62. In another example, the retention feature 64 may be elastically deformed, moved into the center aperture 44 of the internally threaded part 34 or past the flange 54, and aligned with the peripheral cavity 62 such that the retention feature 64 can thereafter assume an original shape within the peripheral cavity 62.

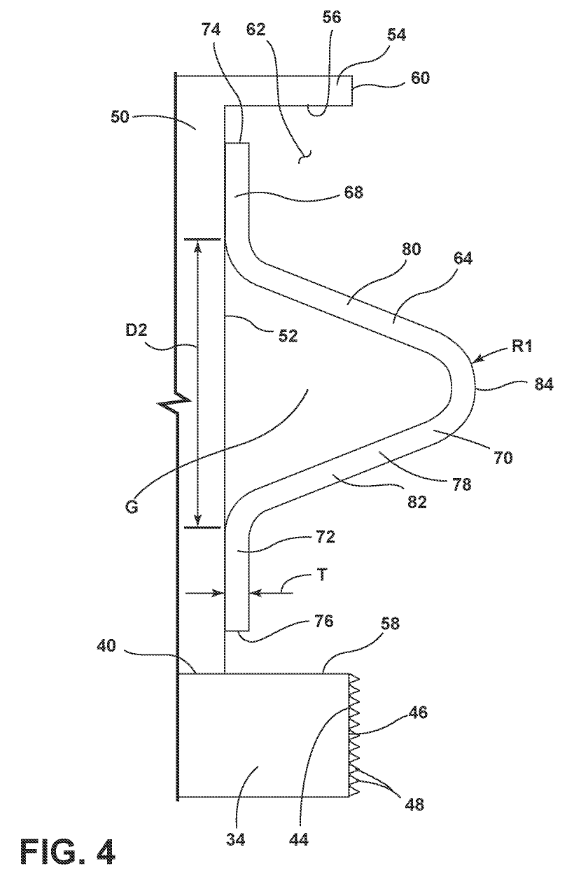

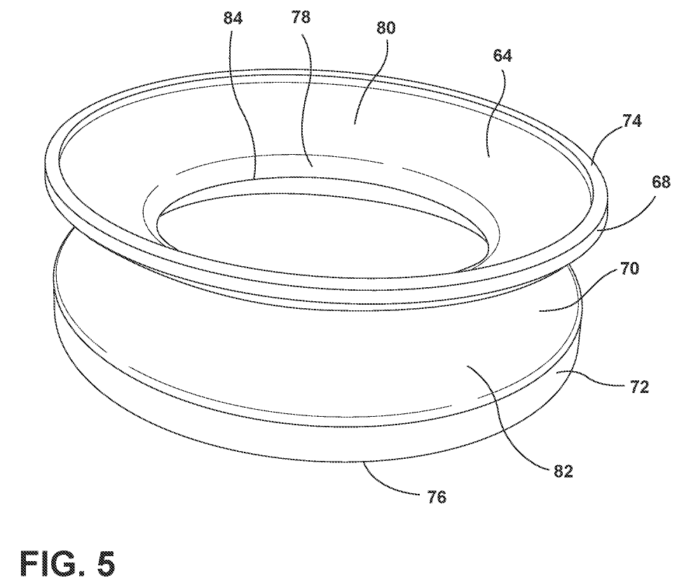

With reference to FIGS. 4 and 5, the retention feature 64 has a first section 68, a second section 70, and a third section 72. The first and third sections 68, 72 of the retention feature 64 extend along the second sidewall 52, the first section 68 defining a top edge 74 of the retention feature 64 and the third section 72 defining a bottom edge 76 of the retention feature 64. The top edge 74 is situated proximate the top wall 56 of the peripheral cavity 62 and the bottom edge 76 is situated proximate the bottom wall 58 of the peripheral cavity 62. Furthermore, the top edge 74 is spaced from the top wall 56 of the peripheral cavity 62 and the bottom edge 76 is spaced from the bottom wall 58 of the peripheral cavity 62 such that the retention feature 64 can translate within the peripheral cavity 62 along the centerline C. The second section 70 of the retention feature 64 interposes the first and third sections 68, 72 and includes a ridge 78 extending toward the centerline C and into the center aperture 44 relative to the first sidewall 46 and the internal threads 48. Particularly, the ridge 78 includes a first portion 80 extending obliquely from the first section 68 and a second portion 82 extending obliquely from the third section 72, where the first and second portions 80, 82 of the ridge 78 converge at an apex 84 of the ridge 78. The first, second, and third sections 68, 70, 72 of the retention feature 64 have a substantially uniform thickness T, and the apex 84 of the ridge 78 defines a first radius R1. In some instances, the thickness T of the retention feature 64 may not be uniform. Additionally, the retention feature 64 may be biased toward the top or bottom walls 56, 58 of the peripheral cavity 62 due to gravity, an adhesive, or a biasing mechanism such as a spring. It is contemplated that the first radius R1 of the apex 84 may match the concave surface of the peripheral cavity 62 and may be squared or pointed, for example.

Referring to FIGS. 1-4, the retention feature 64 defines a third diameterØ3 at the apex 84 of the ridge 78, where the third diameter Ø3 is less than the second diameter Ø2 of the center aperture 44 and the first diameter Ø1 of the externally threaded part 26. Accordingly, the retention feature 64 is configured to elastically deform when the retention feature 64 receives the externally threaded part 26. When the axial fastening system 10 is moved from the unassembled position to the partially assembled position, the free end 32 of the externally threaded part 26 is rotatably received by the bottom side 42 of the internally threaded part 34. Thereafter, the free end 32 advances axially through the center aperture 44 and passes through the retention feature 64. When the free end 32 reaches the retention feature 64, the free end 32 contacts the second portion 82 of the ridge 78 proximate the apex 84. Here, contact between the ridge 78 and the externally threaded part 26 may create resistance against axial movement of the externally threaded part 26 through the retention feature 64. When the free end 32 of the externally threaded part 26 advances further through the center aperture 44 of the internally threaded part 34, the free end 32 passes through the retention feature 64, and the externally threaded part 26 pushes the apex 84 of the ridge 78 radially outward. Accordingly, the apex 84 is elastically and laterally displaced toward the second sidewall 52 of the peripheral cavity 62. Simultaneously, the ridge 78 imposes a compressive force on the externally threaded part 26, which may result in a prevailing torque between the internally threaded part 34 and the externally threaded part 26. Furthermore, when the retention feature 64 is displaced by the externally threaded part 26, a second distance D2 between the first and third sections 68, 72 of the retention feature 64 increases. Accordingly, the retention feature 64 is deformed in the partially assembled position. The displacement of the ridge 78 may be sustained or increase as the free end 32 of the externally threaded part 26 advances through the retention feature 64 until the ridge 78 is aligned with the peripheral groove 36. Accordingly, the compressive force imposed on the externally threaded part 26 by the retention feature 64 may be sustained or increase as the free end 32 of the externally threaded part 26 advances through the retention feature 64 until the ridge 78 is aligned with the peripheral groove 36.

According to some aspects, the first section 68 may slide along the second sidewall 52 toward the top wall 56, and/or the third section 72 may slide along the second sidewall 52 toward the bottom wall 58 when the externally threaded part 26 displaces the ridge 78 of the retention feature 64. When the externally threaded part displaces the retention feature 64, a prevailing torque between the externally threaded part 26 and the internally threaded part 34 results. Alternatively, any prevailing torque between the externally threaded part 26 and the internally threaded part 34 resulting from the compressive force imposed on the externally threaded part 26 by the retention feature 64 may be trivial. In some instances, the bottom edge 76 of the retention feature 64 may abut the bottom wall 58 of the peripheral cavity 62 when the axial fastening system 10 is in the unassembled position such that, when the compressive force is imposed on the retention feature 64 by the externally threaded part 26, the first section 68 of the retention feature 64 slides along the second sidewall 52 and the third section 72 of the retention feature 64 does not slide along the second sidewall 52. Similarly, the top edge 74 of the retention feature 64 may abut the top wall 56 of the peripheral cavity 62 when the axial fastening system 10 is in the unassembled position such that, when the compressive force is imposed on the retention feature 64 by the externally threaded part 26, the third section 72 slides along the second sidewall 52 and the first section 68 does not slide along the second sidewall 52.

Referring still to FIGS. 1-4, when the axial fastening system 10 is moved from the partially assembled position to the fully assembled position, the externally threaded part 26 advances axially through the internally threaded part 34 until the retention feature 64 comes into alignment with the peripheral groove 36. When the retention feature 64 aligns with the peripheral groove 36, contact between the externally threaded part 26 and the retention feature 64 is terminated, and the compressive force imposed on the externally threaded part 26 by the retention feature 64 is eliminated, thereby eliminating the lateral displacement of the apex 84 of the ridge 78 of the retention feature 64. Accordingly, the second distance D2 between the first and third sections 68, 72 of the retention feature 64 decreases as the first and/or third sections 68, 72 slide along the second sidewall 52. At the fully assembled position, any prevailing torque between the externally threaded part 26 and the internally threaded part 34 resulting from contact between the retention feature 64 and the externally threaded part 26 is eliminated. According to some aspects, the deformation of the retention feature 64 resulting from contact between the retention feature 64 and the externally threaded part 26 is decreased but not entirely eliminated when the axial fastening system 10 is moved from the partially assembled position to the fully assembled position. As a result, the ridge 78 of the retention feature 64 extends into and is in contact with the peripheral groove 36 in the fully assembled position, the compressive force between the externally threaded part 26 and the retention feature 64 is decreased but not eliminated, and any prevailing torque between the externally threaded part 26 and the internally threaded part 34 resulting from contact between the retention feature 64 and the externally threaded part 26 is decreased but not eliminated.

The engagement between the retention feature 64 of the internally threaded part 34 and the peripheral groove 36 of the externally threaded part 26 provides resistance against axial movement of the internally threaded part 34 relative to the externally threaded part 26 and vice versa. The magnitude of the axial resistance may vary depending on the geometry of the peripheral groove 36 and the parameters of the retention feature 64 as described in more detail below. For example, the axial resistance may be higher when the peripheral groove 36 is deep and/or the lips 66 of the peripheral groove 36 extend orthogonally relative to the centerline C of the center aperture 44 as compared to when the peripheral groove 36 is shallow and/or the lips 66 of the peripheral groove 36 are chamfered. According to some aspects, the ridge 78 of the retention feature 64 may snappingly and/or slidably engage the peripheral groove 36. The ridge 78 may additionally be displaced in a direction along the centerline C resulting from the free end 32 of the externally threaded part 26 coming into contact with the ridge 78 and advancing toward the top side 40 of the internally threaded part 34 when the axial fastening system 10 is moved from the unassembled position to the partially assembled position. The ridge 78 may also be displaced in a direction along the centerline C resulting from one of the pair of lips 66 of the peripheral groove 36 coming into contact with the ridge 78 when the axial fastening system 10 is moved from the fully assembled position to another position.

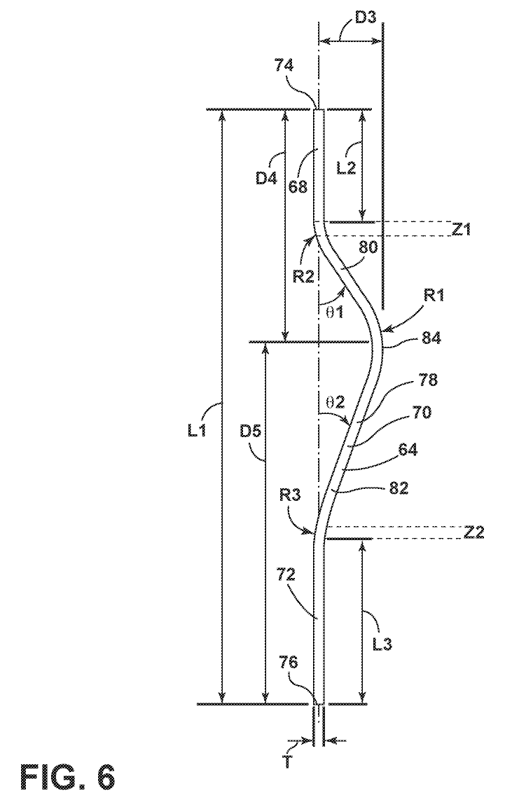

With reference to FIGS. 4 and 6, The retention feature 64 has an overall length L1. The first section 68 defines a first section length L2, and the third section 72 defines a third section length L3. A first angle θ1 is defined between the first portion 80 of the ridge 78 and the second sidewall 52 of the peripheral cavity 62, and a second angle θ2 is defined as an angle between the second portion 82 of the ridge 78 and the second sidewall 52 of the peripheral cavity 62. The apex 84 of the ridge 78 is laterally spaced from the first and third sections 68, 72 by a third distance D3 such that a gap G interposes the second sidewall 52 and the apex 84. The top edge 74 of the first section 68 is longitudinally spaced from the apex 84 of the ridge 78 by a fourth distance D4, and the bottom edge 76 of the third section 72 is longitudinally spaced from the apex 84 of the ridge 78 by a fifth distance D5. A first transition section Z1 interposes the first and second sections 68, 70 of the retention feature 64, and a second transition section Z2 interposes the second and third sections 70, 72. The first transition section Z1 defines a second radius R2, and the second transition section Z2 defines a third radius R3. The thickness T and the overall length L1 of the retention feature 64, the first and third section lengths L2, L3, the first and second anglesθ1, θ2, the third, fourth, and fifth distances D3, D4, D5, the second and third radii R2, R3, and the material from which the retention feature 64 is made are retention feature parameters.

With reference to FIGS. 1-6, the elastic retention feature 64 has a predetermined stiffness such that the ridge 78 exerts a lateral compression force on the externally threaded part 26 when the apex 84 is displaced toward the second sidewall 52 by the externally threaded part 26. One or more of the retention feature parameters may be modified during the manufacturing of the retention feature 64 to achieve a desired stiffness of the retention feature 64 and/or a desired geometry of the retention feature 64 that imposes the desired amount of resistance against axial movement of the internally threaded part 34 relative to the externally threaded part 26 and vice versa when the axial fastening system 10 is in the fully assembled position. It is contemplated that the retention feature 64 may also exert a force in a direction along the centerline C of the center aperture 44 on the externally threaded part 26 in instances where the ridge 78 is displaced along the centerline C or is in contact with one or both of the pair of lips 66 of the peripheral groove 36. It is also contemplated that the retention feature parameters, the stiffness of the retention feature 64, the geometry of the retention feature 64, and the geometry of the peripheral groove 36 may be configured such that a user is unable to move the axial fastening system 10 from the fully assembled position to another position.

According to some aspects, when the retention feature 64 has a greater stiffness, the resistance against axial movement of the internally threaded part 34 relative to the externally threaded part 26 and vice versa is increased as compared to when the retention feature 64 has a lesser stiffness. The stiffness of the retention feature 64 may increase when the overall length L1 decreases, the third distance D3 increases, the first angleθ1 increases, the second angle θ2 increases, the first section length L2 increases, the third section length L3 increases, the first radius R1 decreases, the second radius R2 decreases, the third radius decreases R3, and/or the thickness T increases. In instances where the first and third section lengths L2, L3 are increased, the top and bottom edges 74, 76 of the retention feature 64 may abut the top and bottom walls 56, 58 of the peripheral cavity 62, respectively, before the apex 84 of the ridge 78 is fully displaced when the axial fastening system 10 moves into the partially assembled position. Here, the stiffness may increase when the top and bottom edges 74, 76 abut the top and bottom walls 56, 58 of the peripheral cavity 62, respectively.

According to various aspects, the first and second angles θ1, θ2 may be the same or different. When the first and second anglesθ1, θ2 are different, the axial resistance between the externally threaded part 26 and the internally threaded part 34 may directionally vary. For example, when the second angle θ2 is greater than the first angle θ1, the resistance against axial movement of the externally threaded part 26 relative to the internally threaded part 34 when the axial fastening system 10 moves from the unassembled position to the partially assembled position may be less than the resistance against axial movement of the externally threaded part 26 relative to the internally threaded part 34 when the axial fastening system 10 moves from the fully assembled position toward the unassembled position. Accordingly, moving the axial fastening system 10 to the fully assembled position from the unassembled position may undergo less resistance than moving the axial fastening system 10 to the unassembled position from the fully assembled position. It is also contemplated that the first and third section lengths L2, L3 may be the same or different. When the first and second section lengths l1, l3 are different, the displacement of the first and third sections 68, 72 in the partially assembled position may be affected. For example, when the first section 68 is shorter than the third section 72, the first section 68 may be slidably displaced more than the third section 72 when the axial fastening system 10 moves to the partially assembled position from another position.

With reference to FIGS. 1-3, it is contemplated that the axial fastening system 10 may have a wide variety of dynamic and stationary applications and may be incorporated into systems such as automotive systems, marine systems, construction systems, and appliance systems. As opposed to the ball stud 24, the externally threaded part 26 may extend from one or more different parts, components, and/or mechanisms in such applications, and the externally threaded part 26 may interact with the internally threaded part 34 as herein described. According to some aspects, the axial fastening system 10 may include an unthreaded bolt and an unthreaded nut, as opposed to the externally threaded part 26 and the internally threaded part 34, where the unthreaded bolt defines the peripheral groove 36 and the unthreaded nut contains the retention feature and is configured to axially receive the unthreaded nut.

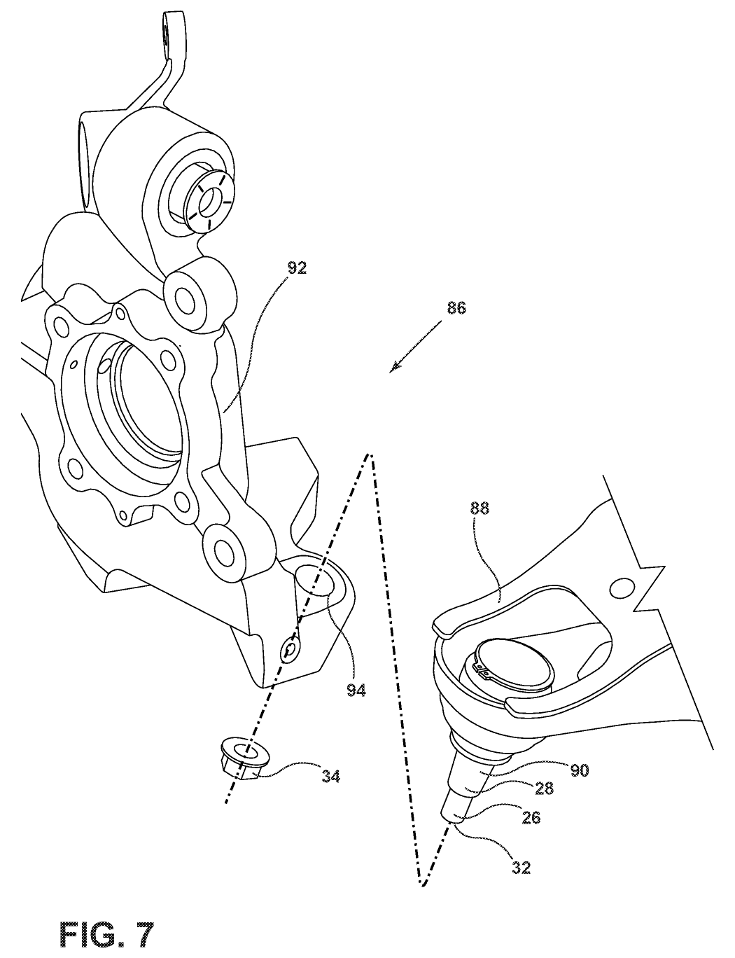

Referring to FIG. 7, the axial fastening system 10 is incorporated into a first vehicle suspension assembly 86 and includes a control arm 88, a ball joint 90 coupled to the control arm 88, and a suspension knuckle 92, where the externally threaded part 26 extends from the ball joint 90. The suspension knuckle 92 defines a knuckle hole 94 configured to receive the externally threaded part 26. When the externally threaded part 26 is received by the knuckle hole 94, the free end 32 of the externally threaded part 26 is rotatably receivable by the internally threaded part 34, and the axial fastening system 10 is operable into the fully assembled position, thereby coupling the control arm 88 to the suspension knuckle 92. Notably, the axial fastening system 10 may be incorporated into a different vehicle suspension assembly having suspension components that are different than the control arm 88 and/or the suspension knuckle 92.

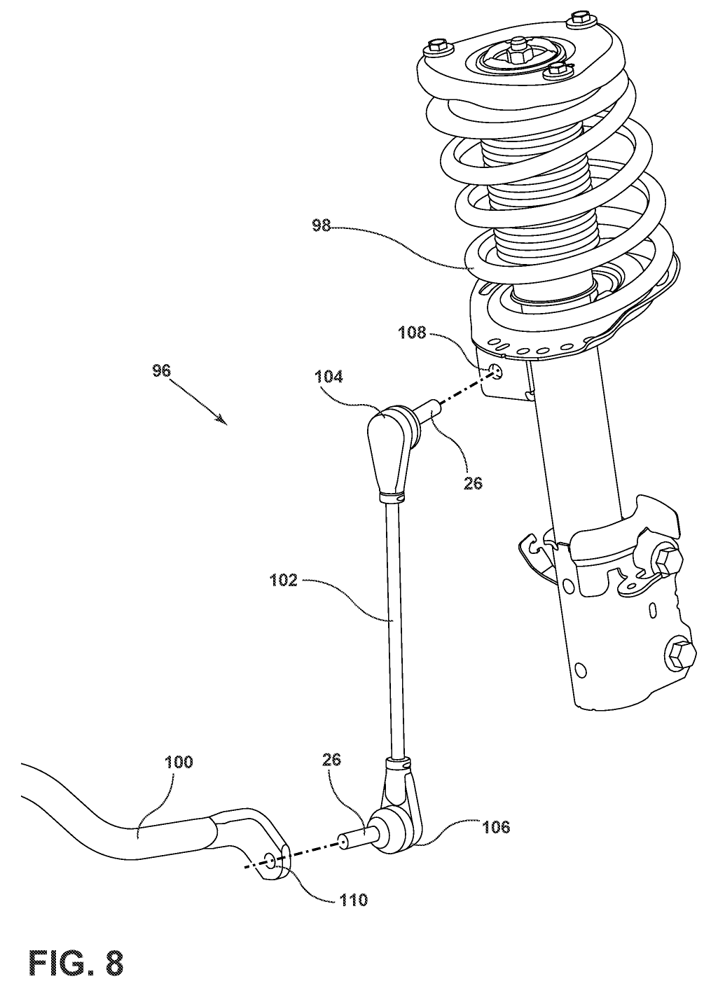

With reference to FIG. 8, the axial fastening system 10 is incorporated into a second vehicle suspension assembly 96 including a spring damper assembly 98, a suspension arm 100, and a stabilizer bar link 102 defining a first end 104 and a second end 106, where a pair of externally threaded parts 26 extend from the first end 104 of the stabilizer bar link 102 and the second end 106 of the stabilizer bar link 102, respectively. One of the externally threaded parts 26 is configured to be received by a first hole 108 defined by the spring damper assembly 98, and one of the externally threaded parts 26 is configured to be received by a second hole 110 defined by the suspension arm 100. When one of the externally threaded parts 26 is received by the first hole 108 of the spring damper assembly 98, the free end 32 thereof is rotatably receivable by an internally threaded part 34 (FIG. 7) that is operable into the fully assembled position. When one of the externally threaded parts 26 is received by the second hole 110 of the suspension arm 100, the free end 32 thereof is receivable by an internally threaded nut 34 that is movable into the fully assembled position. Thus, when the externally threaded parts 26 of the stabilizer bar link 102 are received by the first and second holes 108, 110, respectively, and are thereafter received by the internally threaded parts 34, respectively, in the fully assembled position, the spring damper 98 is coupled to the suspension arm 100. Notably, the axial fastening system 10 may be incorporated into a different vehicle suspension assembly having suspension components that are different than the spring damper 98 and/or the suspension arm 100.

The axial fastening system 10 described herein has a number of advantages over fastener locking mechanisms known in the art. For example, when the retention feature 64 of the internally threaded part 34 engages with the peripheral groove 36 of the externally threaded part 26, a resistance between axial movement of the internally threaded part 34 relative to the externally threaded part 26 is provided. The engagement of the retention feature 64 and the peripheral groove 36 may also decrease or eliminate any prevailing torque between the externally threaded part 26 and the internally threaded part 34, which may decrease wearing of the externally threaded part 26 and the internally threaded part 34 and may enhance robustness of the locked relationship between the externally threaded part 26 and the internally threaded part 34 in the fully assembled position. Separation of the externally threaded part 26 and the internally threaded part 34 may thus be further inhibited as compared to known fastener locking systems. The axial fastening system 10 described herein may also eliminate the need for additional, secondary locking mechanisms for preventing separation of components of fastening systems.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A trailer hitch axial fastening system, comprising:
a trailer ball configured to be removably coupled to a trailer hitch of a vehicle and to receive an accessory component;
a threaded bolt extending from the trailer ball, the threaded bolt defining a free end and a peripheral groove spaced from the free end;
a threaded nut configured to rotatably receive the threaded bolt, the threaded nut defining a top side, a bottom side, and a center aperture, wherein the center aperture defines a first sidewall lined with internal threads and a peripheral cavity proximate the top side of the threaded nut, and wherein the peripheral cavity defines a top wall, a bottom wall, and a second sidewall extending between the top and bottom walls, wherein the second sidewall is recessed relative to the first sidewall; and
an elastic annular ring disposed within the peripheral cavity of the threaded nut, wherein the elastic annular ring applies a compression force around the threaded bolt when the threaded bolt extends through the threaded nut such that the elastic annular ring is not aligned with the peripheral groove, and wherein the elastic annular ring extends into the peripheral groove when the threaded bolt extends through the threaded nut such that the elastic annular ring is aligned with the peripheral groove, the elastic annular ring including a ridge having a first radius, wherein the ridge is configured to extend into the peripheral groove when the threaded bolt extends through the threaded nut such that the elastic annular ring is aligned with the peripheral groove.

2. The trailer hitch axial fastening system of claim 1, wherein the elastic annular ring further includes:
a first section extending along the second sidewall;
a second section laterally defining the ridge; and
a third section extending along the second sidewall, wherein the second section of the elastic annular ring interposes the first and third sections of the elastic annular ring.

3. The trailer hitch axial fastening system of claim 2, wherein when the threaded bolt extends through the threaded nut such that the elastic annular ring is not aligned with the peripheral groove, the ridge of the elastic annular ring is laterally displaced toward the second sidewall of the peripheral cavity.

4. The trailer hitch axial fastening system of claim 3, wherein when the threaded bolt extends through the threaded nut such that the elastic annular ring is not aligned with the peripheral groove, the first section of the elastic annular ring is slidably displaced toward the top wall and/or the third section of the elastic annular ring is slidably displaced toward the bottom wall.

5. The trailer hitch axial fastening system of claim 4, wherein the first and third sections of the elastic annular ring are substantially equal in length.

6. The trailer hitch axial fastening system of claim 5, wherein the elastic annular ring further includes:
a first transition section interposing the first and second sections, wherein the first transition section defines a second radius; and
a second transition section interposing the second and third sections, wherein the second transition section defines a third radius.

7. The trailer hitch axial fastening system of claim 6, wherein the second and third radii are substantially equal.

8. The trailer hitch axial fastening system of claim 7, wherein the threaded nut is removably coupled to the threaded bolt when the ridge of the elastic annular ring is received by the peripheral groove.

9. The trailer hitch axial fastening system of claim 8, wherein the center aperture of the threaded nut defines a first diameter, wherein the ridge of the elastic annular ring defines a second diameter, and wherein the first diameter is greater than the second diameter.

10. A fastening system, comprising:
an externally threaded part having a free end and a peripheral groove spaced from the free end;
an internally threaded part having a top side and a bottom side, wherein the internally part defines a center aperture extending between the top side and the bottom side along a centerline, wherein the center aperture defines a first sidewall, and wherein the internally threaded part defines a peripheral cavity proximate the top side, the peripheral cavity having a top wall, a bottom wall, and a second sidewall extending between the top and bottom walls, wherein the second sidewall is recessed relative to the first sidewall of the center aperture;
a retention feature disposed within the peripheral cavity and configured to engage with the peripheral groove when the externally threaded part extends through the internally threaded part such that the retention feature aligns with the peripheral groove, the retention feature including:
a first section extending along the second sidewall of the peripheral cavity and defining a top edge of the retention feature;
a second section laterally spaced from the second sidewall of the peripheral cavity; and
a third section extending along the second sidewall of the peripheral cavity and defining a bottom edge of the retention feature, wherein the second section interposes the first and third sections.

11. The fastening system of claim 10, wherein the second section includes a ridge having an apex, and wherein the apex is displaced toward the second sidewall when the externally threaded part extends through the internally threaded part and the ridge is not aligned with the peripheral groove.

12. The fastening system of claim 11, wherein the retention feature defines a uniform thickness.

13. The fastening system of claim 12, wherein an overall length of the retention feature is less than a length of the second sidewall.

14. The fastening system of claim 13, wherein a distance between the first and second sections of the retention feature is greater when the externally threaded part extends through the internally threaded part and the ridge is not aligned with the peripheral groove as compared to when the ridge extends into the peripheral groove.

15. The fastening system of claim 11, wherein when the externally threaded part extends through the internally threaded part and the ridge extends into the peripheral groove, the ridge provides axial resistance against removing the internally threaded part from the externally threaded part without providing significant prevailing torque between the externally threaded part and the internally threaded part.

16. An axial fastening system, comprising
an externally threaded part having a free end and a peripheral groove spaced from the free end;
an internally threaded part configured to rotatably receive the externally threaded part, the internally threaded part having a top side and a bottom side, wherein the internally threaded part defines a center aperture having a first sidewall extending between the top and bottom sides along a centerline, wherein the center aperture defines a peripheral cavity proximate the top side of the internally threaded part, the peripheral cavity having a top wall, a bottom wall, and a second sidewall extending between the top and bottom walls, wherein the second sidewall is recessed relative to the first sidewall of the center aperture; and
a retention feature disposed within the peripheral cavity, wherein the retention feature is configured to extend into the peripheral groove of the externally threaded part, the retention feature including:
a first section extending along the second sidewall of the peripheral cavity;
a second section defining a ridge extending toward the centerline, wherein the second section is spaced from the second sidewall when the retention feature extends into the peripheral groove of the externally threaded part; and
a third section extending along the second sidewall of the peripheral cavity.

17. The axial fastening system of claim 16, wherein the ridge of the retention feature further includes:
a first portion extending from the first section; and
a second portion extending from the second section, wherein the second portion converges with the first portion at an apex of the ridge.

18. The axial fastening system of claim 17, wherein the retention feature further includes: a first transition section interposing the first section of the retention feature and the first portion of the ridge, wherein the first transition section defines a first radius; and
a second transition section interposing the third section of the retention feature and the second portion of the ridge, wherein the second transition section defines a second radius.

19. The axial fastening system of claim 16, wherein the ridge extends into the center aperture further than the first sidewall.

20. The axial fastening system of claim 16, wherein the first section of the retention feature is substantially parallel to the third section of the retention feature.
